(19) United States
(12) Patent Application Publication
(10) Pub. No.: US 2013/0100227 A1
(43) Pub. Date: Apr. 25, 2013

(54) VIDEO COMMUNICATION SYSTEM AND METHOD

(71) Applicant: PING-YANG CHUANG, Tu-Cheng (TW)

(72) Inventor: PING-YANG CHUANG, Tu-Cheng (TW)

(73) Assignee: HON HAI PRECISION INDUSTRY CO., LTD., Tu-Cheng (TW)

(21) Appl. No.: 13/585,850

(22) Filed: Aug. 15, 2012

(30) Foreign Application Priority Data
Oct. 19, 2011 (TW) 100137992

(51) Int. Cl. H04N 7/14; H04N 13/02

(52) U.S. Cl. 348/14.01; 348/47; 348/E07.079; 348/E13.074

(57) ABSTRACT

A 3D image rectifying method includes: controlling at least two cameras to capture depth images in front of an electronic device periodically and forms 3D images according to the captured depth images; recognizing the face of the user from the formed 3D image; determining at least one deflection angle which the detected face deflected from a front view of the face in the 3D image; separating the recognized face from the background of the 3D image; and rotating the recognize face according to the at least one deflection angle to rectify the recognize face to the front view of the face and display the rectified image.

### BACKGROUND

1. Technical Field

The present disclosure relates to a video communication system, and, particularly to a system for rectifying the images transmitted in the video communication system and a method using the same.

2. Description of Related Art

Video communication system is widely used when having a remote chat or remote meeting. When using a video communication system for chatting or meeting, the user sometimes may not face a camera of the video communication system and the camera cannot capture the front view of a face of the user, thereby the user at the other end cannot get the front view of the face of the user.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a structure diagram of a video communication system in accordance with one embodiment.

FIG. 2 is a block diagram of an electronic device of the video communication system of FIG. 1

FIG. 3 is a flowchart of a method for rectifying images transmitted in the video communication system of the FIG. 1.

### DETAILED DESCRIPTION

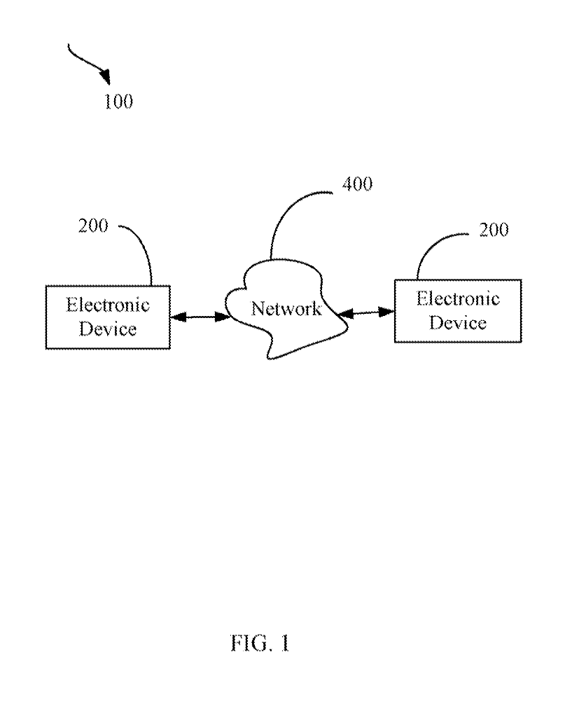

FIG. 1 is a structure diagram of a video communication system in accordance with one embodiment. The video communication system 100 includes at least two electronic devices 200, which can communicate with each other through the network 400. The network 400 can be a wired network or a wireless network.

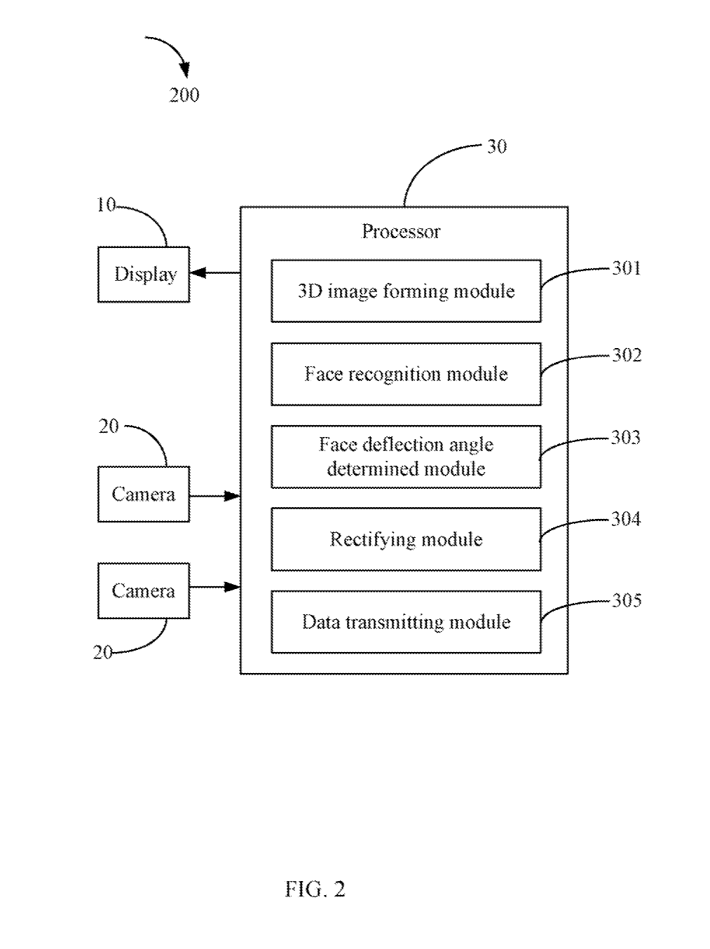

FIG. 2 is a block diagram of the electronic device 200 of the video communication system 100 of FIG. 1. The electronic device 200 includes a display 10 and at least two cameras 20. The cameras 20 are 3D cameras and configured for capturing depth images in front of the electronic device 200. The at least two cameras 20 are set symmetrically on the electronic device 200 to capture images. In the embodiment, two cameras 20 are taken for example and respectively arranged in the left side and right side of the electronic device 200.

The electronic device 200 further includes a processor 30. The processor 30 includes a 3D image forming module 301, a face recognition module 302, a face deflection angle determined module 303, a rectifying module 304, and a data transmitting module 305. The 3D image forming module 301 is used for controlling the cameras 20 to capture depth images in front of the electronic device 200 periodically and forms 3D images according to the captured depth images. The method for forming the 3D image according to the captured depth images is familiar to the skilled person in this art, so the description for such method is omitted here.

The face recognition module 302 is used for recognizing a face of the user from the formed 3D image. The deflection angle determining module 303 is used for determining the deflection angles that the detected face deflected from a front view of the face in the 3D image in vertical direction and Horizontal direction. The method for determining the deflection angle of the face can refer to the technology which is titled as “Support Vector Regression and Classification Based Multi-View Face Detection and Recognition” and published by Y. Li, S. Gong and H. Liddell in IEEE international conference on Automatic Face and Gesture Recognition 2000. The rectifying module 304 is used for separating the recognized face from the background of the 3D image and rotating the recognize face according to the deflection angles of the face in the 3D image in vertical direction and horizontal direction to rectify the recognized face to a front face facing to the display 10. The data transmitting module 305 is used for transmitting the rectified 3D image through the network 400 to the electronic devices 200 at the other end.

In other embodiment, the electronic device 200 can rectify the 3D image transmitted from another electronic devices 200 of the video communication system 100. The rectified image is displayed on the display 10 of the electronic devices 200.

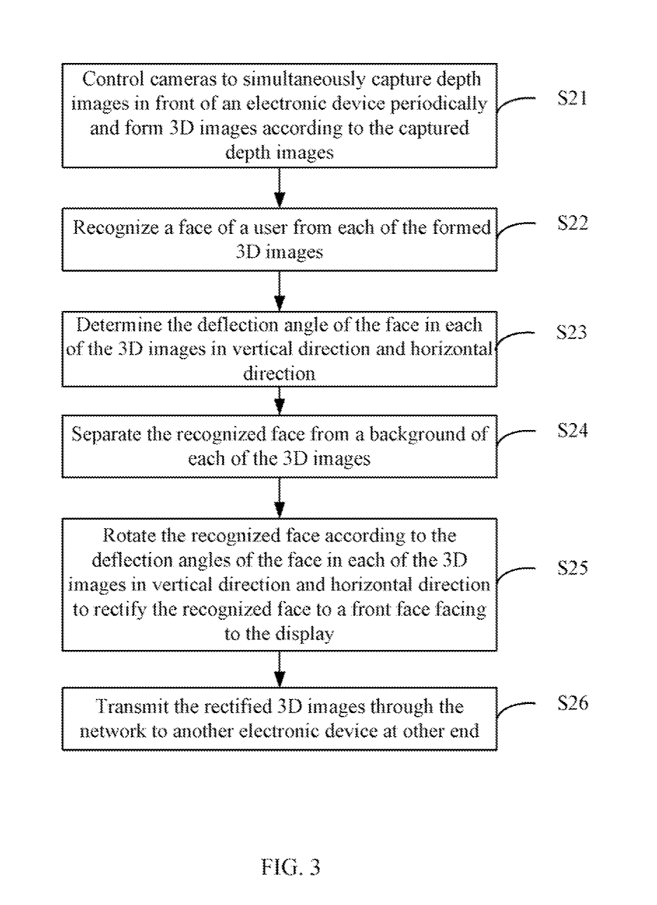

FIG. 3 is a flowchart of a method for rectifying the images transmitted in the video communication system 1 of the FIG. 1.

In step S21, the 3D image forming module 301 controls the cameras 20 to capture depth images in front of the electronic device 200 periodically and forms 3D images according to the captured depth images.

In step S22, the face recognition module 302 recognizes the face of the user from the formed 3D image.

In step S23, the deflection angle determining module 303 determines the deflection angle of the face in the 3D image in vertical direction and horizontal direction.

In step S24, the rectifying module 304 separates the recognized face from the background of the 3D image.

In step S25, the rectifying module 304 rotates the recognized face according to the deflection angles of the face in the 3D image in vertical direction and horizontal direction to rectify the recognized face to a front face facing to the display 10.

In step S26, the data transmitting module 305 transmits the rectified 3D image through the network 400 to the electronic devices 200 at the other end.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
a display;
at least two cameras configured for capturing depth images in front of the display; and
a processor comprising:
a 3D image forming module for controlling the at least two cameras to capture depth images in front of the electronic device periodically and forms 3D images according to the captured depth images;
a face recognition module for recognizing a face of a user from each of the formed 3D images;
a deflection angle determining module for determining at least one deflection angle that the detected face deflected from a front view of the face in each of the 3D images; and
a rectifying module for separating the recognized face from a background of each of the 3D images and rotating the recognized face according to the at least one deflection angle to rectify the recognized face to the front view of the face and display each of the rectified images.

2. The electronic device as described in claim 1, further comprising a data transmitting module for transmitting the rectified 3D image through a network to another electronic device.

3. The electronic device as described in claim 1, wherein the 3D images are transmitted from another electronic device through a network.

4. The electronic device as described in claim 1, wherein the at least two cameras are set symmetrically on the electronic device.

5. The electronic device as described in claim 1 wherein the number of the at least two cameras is two and the two cameras are respectively arranged in the left side and right side of the electronic device.

6. The electronic device as described in claim 1, wherein the number of the at least one deflection angle is two, one of the two deflection angles is the detected face deflected from the front view of the face in a vertical direction and the other one of the two deflection angle is the detected face deflected from the front view of the face in a horizontal direction.

7. A video communication system, comprising:
a network;
at least two electronic devices which communicates with each other through the network;
each of the at least two electronic device comprising:
a display;
at least two cameras configured for capturing depth images in front of the display; and
a processor comprising:
a 3D image forming module for controlling the at least two cameras to capture depth images in front of the electronic device periodically and forms 3D images according to the captured depth images;
a face recognition module for recognizing a face of a user from each of the formed 3D images;
a deflection angle determining module for determining at least one deflection angle which the detected face deflected from a front view of the face in each of the 3D images;
a rectifying module for separating the recognized face from a background of each of the 3D images and rotating the recognized face according to the at least one deflection angle to rectify the recognized face to the front view of the face and display the rectified image.

8. The system as described in claim 7, wherein each of the at least two electronic device further comprising a data transmitting module for transmitting the rectified 3D image through the network to another electronic device of the at least two electronic device.

9. The system as described in claim 7, wherein the 3D images rectified by one of the at least two electronic devices are transmitted from another electronic device of the at least two electronic device.

10. The system as described in claim 7, wherein the at least two cameras are set symmetrically on the electronic device.

11. The system as described in claim 7, wherein the number of the at least two cameras is two and the two cameras are respectively arranged in the left side and right side of the electronic device.

12. The system as described in claim 7, wherein the number of the at least one deflection angle is two, one of the two deflection angle is the detected face deflected from the front view of the face in a vertical direction and the other one of the two deflection angle is the detected face deflected from the front view of the face in a horizontal direction.

13. A 3D image rectifying method comprising:
controlling at least two cameras to capture depth images in front of an electronic device periodically and forms 3D images according to the captured depth images;
recognizing the face of the user from the formed 3D image;
determining at least one deflection angle which the detected face deflected from a front view of the face in the 3D image;
separating the recognized face from a background of each of the 3D images and rotating the recognized face according to the at least one deflection angle to rectify the recognized face to the front view of the face and display each of the rectified images.

14. The method as described in claim 13, further comprising the step of transmitting the rectified 3D image through a network to another electronic device.

15. The method as described in claim 13, wherein the number of the at least one deflection angle is two, one of the two deflection angle is the detected face deflected from the front view of the face in a vertical direction and the other one of the two deflection angle is the detected face deflected from the front view of the face in a horizontal direction.
